(19) United States
(12) Patent Application Publication
(10) Pub. No.: US 2007/0276711 A1
(43) Pub. Date: Nov. 29, 2007

(54) Method of monitoring procedural compliance of business processes

(76) Inventors: Simon Shiu, Bristol (GB); Adrian Baldwin, Bristol (GB); Yolanta Beresnevichiene, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/438,359

(22) Filed: May 23, 2006

(51) Int. Cl. G06F 17/50

(52) U.S. Cl. 705/7

(57) ABSTRACT

A method of monitoring compliance with a business process comprising the steps of: generating, from a record of the business process and further information not expressed explicitly within the record of the process, a canonical model of all processes of a given genre which are to be monitored; applying the canonical model to the process as recorded to generate a process-specific model in which specific process operations are expressed in canonical form; and measuring the performance of the process by generating reports, based on the algorithms contained within the process-specific model and data generated by actual performance of the process, thereby to indicate whether the process is compliant.

### BACKGROUND TO THE INVENTION

The present invention relates to the monitoring of business processes such as, for example, operational processes such as IT operations or financial processes. Following the advent of several instances of spectacular financial irregularity in recent years, those people who have the authority to authorise financial transactions on behalf of large corporations have been given greater responsibility. A Chief Executive, for example, may now have significantly more onerous duties to ensure the performance of transactions with financial regularity; significantly more onerous duties to account accurately and significantly for those transactions; and significantly greater liability for any failure to discharge adequately either of the aforementioned duties. Frequently, the necessity of ensuring compliance with the appropriate procedures and the liability of those at the very top of an organisation for all irregularities is at odds with the increasing search for reductions in cost, streamlining of procedures and the outsourcing of non-core activities. The present invention addresses the apparent conflict between these two ostensibly antagonistic requirements.

### SUMMARY OF THE INVENTION

An aspect of the present invention provides a method of monitoring compliance with a business process comprising the steps of:
generating, from a record of the business process and further information not expressed explicitly within the record of the process, a canonical model of all processes of a given genre which are to be monitored;
applying the canonical model to the process as recorded to generate a process-specific model in which specific process operations are expressed in canonical form; and
measuring the performance of the process by generating reports, based on the algorithms contained within the process-specific model and data generated by actual performance of the process, thereby to indicate whether the process is compliant.

### BRIEF DESCRIPTION OF DRAWINGS

Embodiments of the present invention will now be described, by way of example, and with reference to the accompanying drawings, in which:

FIG. 1 is a schematic illustration of the architecture of a system in which the present invention is employed;

FIG. 2 is an extract from a spreadsheet in which regulatory processes are recorded;

FIG. 3 is a canonical model of the processes in the spreadsheet of FIG. 2;

FIG. 4 is a model of the process task in FIG. 2 as expressed through the application of the canonical model;

FIG. 5 is a schematic representation of the reports which are generated by implementing the model of FIG. 4; and

FIG. 6 is modification according to which similar types of modelled element are monitored together across a plurality of different processes.

### DESCRIPTION OF PREFERRED EMBODIMENTS

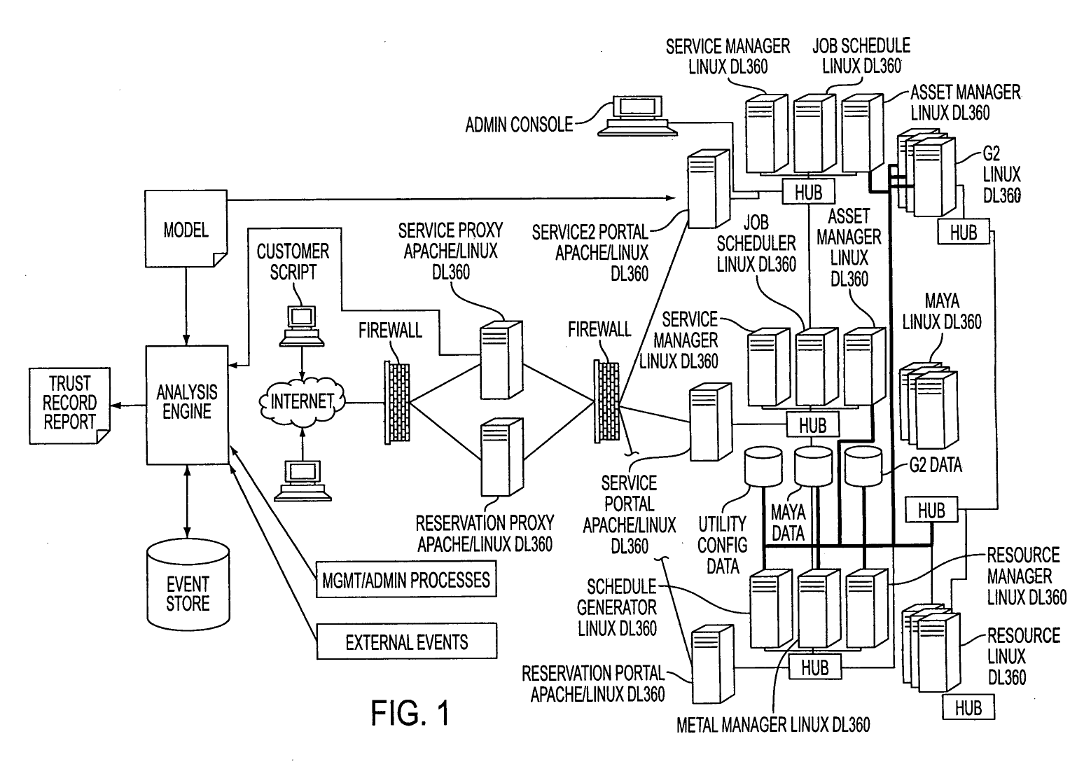

The present invention is applicable across a wide variety of processes requiring monitoring but may be applied to particular advantage to those processes which involve a degree of financial risk. Accordingly, the invention will be illustrated by reference to financial processes. At its highest level of abstraction, the present invention provides the ability to generate a report which illustrates whether, and the extent to which, processes are being executed in the proper manner. Referring now to FIG. 1, a model of the process or processes which are to be monitored is generated. Software agents are then deployed at various network nodes where the individual tasks comprising the processes are executed, which agents monitor and return data on the implementation of the elements of the process which has been modelled. This data is interpreted by an analysis engine which generates reports indicating the extent to which the approved procedures have been complied with. Preferably the reports are generated in a hierarchy which has a correspondence with the model so that anyone reading a report may, if they choose, be able to traverse the hierarchy of reports to investigate events at whatever level of detail they choose. The result is a Trust Record.

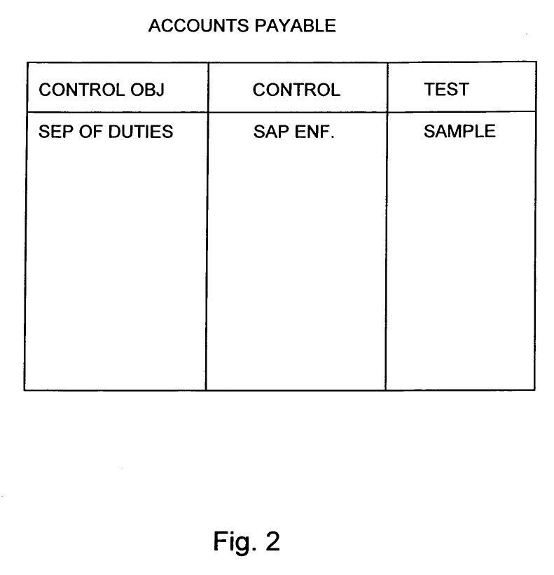

Generation of a record from a real world example will now be described in detail. Referring now to FIG. 2, a single row of a multiple row spreadsheet is illustrated. The spreadsheet is a very typical example of one of many such spreadsheets which large organisations used to record the various processes which must take place and the rules which should be adhered to in implementing those processes. In the present example, the spreadsheet is one relating to the various elemental tasks involved in the process of dealing with Accounts Payable, i.e. incoming invoices. The spreadsheet contains only three columns: the first contains an epithet for the particular element of the process which is being represented in the row in question, together with its content—e.g. the nature of the rule or action which is required to be taken. Here, the process element is a rule called ‘Separated Duties’ and requires that an account clerk who ‘parks’ an invoice (i.e. submits the invoice for payment) is not the clerk who authorises the invoice for payment. The spreadsheet also details the risk associated with failing to adhere to the rule, which, in this instance has been evaluated as an increased risk of duplicate payments of a single, given invoice. Thus far, all that has been described is the manner in which many large organisations choose to record a rule such as this. In a majority of cases, although the many procedures are typically recorded in something akin to hard copy spreadsheets (which, although they may be stored as soft copies, have very little computational utility), the processes are implemented on large scale Enterprise Resource Planning systems, such as those provided by SAP™.

A first step in implementing the present invention is to generate, on the basis of information obtained from the organisation in question—which typically will include information which is explicit from the various processes recorded in the spreadsheets such as the one illustrated above as well as implicit information on the manner in which processes are implemented, a canonical model of the process. As mentioned, this model will desirably include information which is very likely not recorded in the spreadsheet explicitly. One frequent reason for this is that those who record the processes in the spreadsheet may consider such information to be too trivial or obvious to record it in explicit form—even though this information could form an integral part of the model subsequently created.

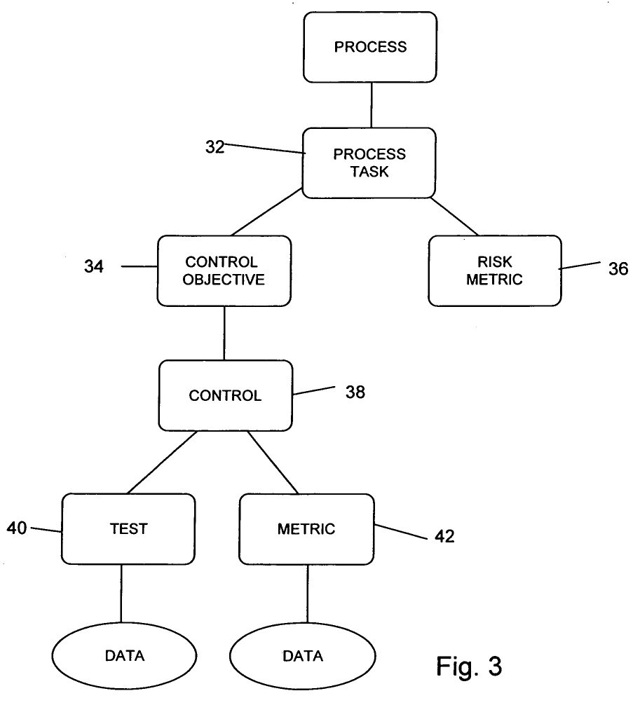

Referring now to FIG. 3, one example of a canonical model for an accounts payable process is illustrated. The model can be thought of as a hierarchy of elements, each of which provides a description of the overall process at a level of abstraction which corresponds to its position within the hierarchy. Each element has a type and the types are typically defined on the basis of the nature of the process which is being modelled. A model element is more explicitly described by one or more other elements lower in the hierarchy and thus it follows that an element can be described in terms of other element types and/or data. Relationships between model elements are modelled by connections between the elements and these relationships define both the relative position of elements in the hierarchy as well, optionally, as defining the manner in which data flowing up the hierarchical abstraction is to be evaluated at each level in the model. Thus, the illustrated canonical model for the accounts payable process has, at it's highest level of abstraction, a model element type which simply defines the process: here, accounts payable. At the next level of abstraction down, element 32 describes the process as a plurality of tasks to be performed. These tasks are likely to be simply those which have been detailed on the spreadsheet (though this is not a hard and fast rule). Each process task 32 can be described by reference to a control objective 34 (which is, as the title suggests, the purpose which placing one or more controls in place in relation to the particular process task in question is supposed to be achieving) and a risk metric 36: an indication of the nature of the risk to which incorrect performance of the task will expose the organisation. The control objective 34 is achieved by the use of one or more controls 38. These controls 38 are the actual operations which are performed or restrictions which are put into place to attempt to ensure that the control objectives are met. Each control is evaluated by a test 40, which is an operation that establishes the extent to which the control is being achieved, and a metric 42, this being a simple algebraic indication of the severity of the control on some relative scale. The metric thus provides an instant indication of how tightly the organisation has chosen to control the process task. To perform either the test 40 or the metric 42 data is required and this is illustrated at 44 and 46 respectively.

It can be seen, by comparing the canonical model with the process task detailed in the spreadsheet row, that the canonical model necessarily includes and formalises within its structure, implicit information such as a separation of the control objective and risk metric, which, on casual consideration can easily be conflated as a single element and is not apparent from the spreadsheet.

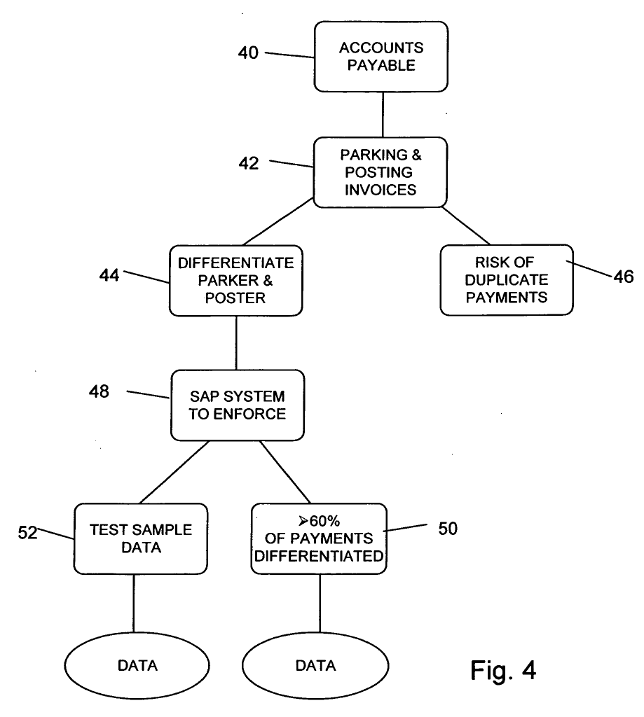

FIG. 4 illustrates the output which is obtained when the canonical model is applied to the process task detailed on the spreadsheet. The process 40 is Accounts payable. The process task 42 is the posting of invoices on the SAP system and the paying of invoices by the SAP system. The control objective 44 is that the person posting the invoice on the system is distinct from the person paying the invoice via the system. The Risk metric 46 is assessed as an increased risk of duplicate payments, whether by fraud or by accident. The control objective is achieved, or sought to be achieved by the control 48, namely that the SAP system constraints are set to enforce this control objective. The metric 50 for the control is that the control objective is achieved in at least 60% of invoice approval instances. The test 52 extracts, via the software agents, a sample of instances of invoice approvals to determine whether the control is operating in accordance with its metric.

From the above exposition, it can clearly be seen that the process of extracting a process task, recorded and elucidated somewhat intuitively in what is essentially hard-copy form, applying a more rigorous modelling technique to the process task, which includes assimilation and representation of implicit information, and then applying that model back to the process task results in a process task whose architecture then takes on a very different and more rigorous form. Equally importantly, however, the form which the process description then takes on enables the extent of compliance with the task to be measured; and measuring at varying levels of abstraction which correspond with those hierarchical levels in the modelled process.

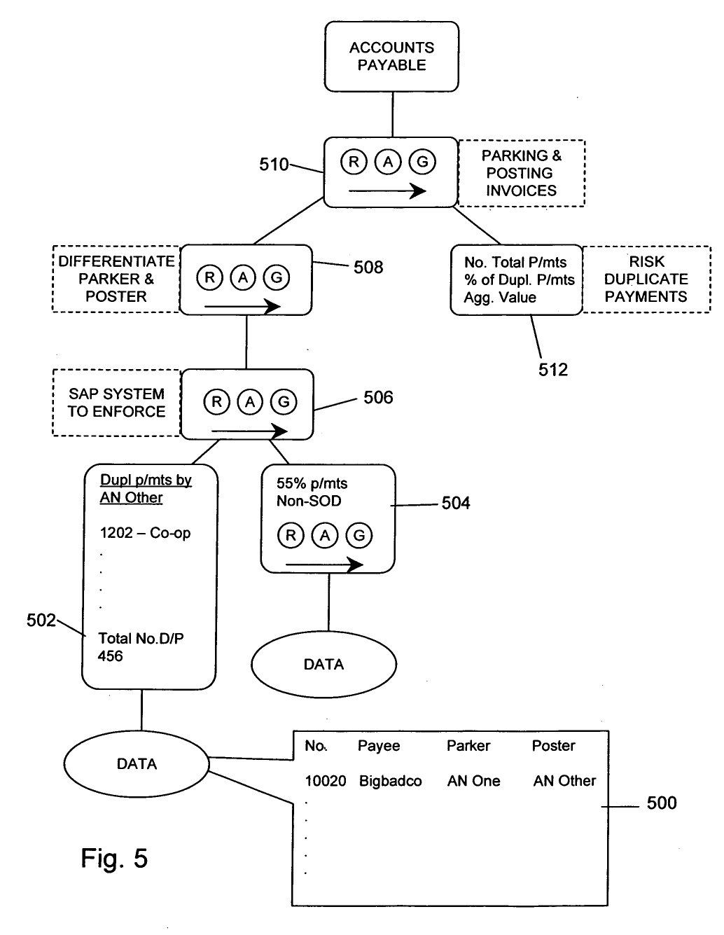

As mentioned previously, the architecture by which this process is implemented includes the provision of software monitoring agents which return data to the event store. These events are then processed and reports generated by the analysis engine; the reports being generated at levels of abstraction corresponding to the hierarchical levels in the model of the processes to which the canonical model has been applied. Thus, referring to FIG. 5, for example reports on the performance of the Parking and Posting process can be generated by encoding the reporting algorithms contained within the model to operate upon the data retained in the event store with the result that, it is possible to acquire a report at whatever level of abstraction within the model it is desired to do so. The lowest level of report obtainable is simply a listing 500 of the raw transaction data showing the payments made by invoice number, the identity of the invoice parker and the invoice payer. At a slightly higher level of abstraction, a report 502 can be obtained which details the test sample data and summarises the total number of payments sampled. A metric-level report 504 details the percentage of payments made in which the duties of parking and posting were not separated (non SOD), together with a ‘traffic light’ indicating a summary status of this metric: green for above the desired threshold by some predetermined margin; amber for in the region of the threshold and red for below it. Similar traffic light summary reports are generated for each of the model elements: SAP System to Enforce (508); Differentiate Parker & Poster (510); and Parking and Posting Invoice Process Task (512). It is important to appreciate, however, that, in each case, these reports signify something different. Thus, at the level of the control objective the report 506 indicator is taking into account the test sample of payments and the metric against which the enforcement of the control that the parker and payer should be different. In this specific instance, the traffic light indicator of report 508 for the control which requires differentiation of parker and poster is actually indicating exactly the same as report 506—the reason for this being simply that there is but a single control in place to achieve the control objective (where more than one control exists, however, they will not be indicating the same thing). Report 510 which summarises the overall performance of the process task is in a similar format, again showing a traffic light indicator of status, but takes into account the risk metric parameters indicated in Report 512. This shows the total number of transactions which have taken place, their value and the total number of duplicate invoices (i.e. invoices that have been paid twice—and which ought only to have been paid once); if the total number of transactions is small then this will operate to reduce the risk; similarly if the aggregate value of these transactions are small this will likewise operate to reduce the risk. The report 510 is thus a status which takes account of both the character of the transactions as monitored and constrained by the controls as well as weighting the status of those transactions in accordance with the level of risk to which, as a result of the number and/or value of the transactions, their performance exposes the organisation.

It is thus apparent that it is possible to evaluate the performance of process tasks at varying levels of abstraction. For example, if the initial status indicator is amber or red, then it may be desirable to ‘drill down’ in the lower level reports to determine exactly what is happening to cause such a status to be shown. In a modification, the reports are monitored and stored and their changing output over time is used to generate an indication of trend. This can be shown with an arrow: horizontal for no change; up for improving; down for getting worse.

An advantage of the present invention lies in the feature that, because the analysis engine which operates upon the data captured by the software monitoring agents and stored in the event store is configured using the algorithms encoded into the model, any change in the process which is then reflected in the model can be immediately reflected in the analysis of the data. Thus, rather than searching to retrieve all of the spreadsheets, for example, upon which such control procedures are recorded and amending them manually, implementation of the change in the model will greatly simplify the encoding of the change in the analysis engine. A further advantage is that where, for example, it is desirable to monitor the performance of certain types of control (such as the enforcement of differentiation between the performance of two interrelated tasks by different personnel) across a variety of different processes, the modelling technique illustrated herein enables the linking of the different control types and a report or reports to be generated which summarise the overall performance of that type of control task.

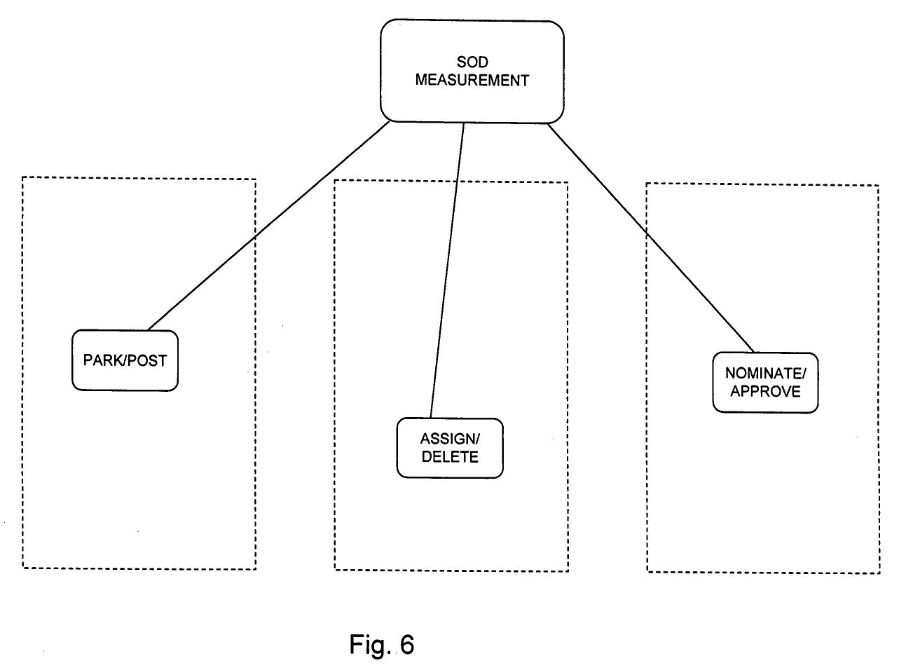

This is illustrated in FIG. 6, where three different processes, one to do with accounts payable, another to do with the management of IT accounts and the third to do with allocation of approved vendor status, each include a model element which is a control to enforce what can generically be termed the separation of duties (SOD). While each process will be measured individually, it may also be desirable to measure, across the organisation the performance of various SOD controls. By modelling processes in the manner illustrated it is possible to link each SOD control element and measure the performance of SOD controls.

1. A method of monitoring compliance with a business process comprising the steps of:
generating, from a record of the business process and further information not expressed explicitly within the record of the process, a canonical model of all processes of a given genre which are to be monitored;
applying the canonical model to the process as recorded to generate a process-specific model in which specific process operations are expressed in canonical form; and
measuring the performance of the process by generating reports, based on the algorithms contained within the process-specific model and data generated by actual performance of the process, thereby to indicate whether the process is compliant.

2. A method according to claim 1 further comprising the steps of: changing the process; modifying the process-specific model to reflect the changes, and measuring the performance of the process by generating reports based on revised algorithms contained within the modified process-specific model and data generated by actual performance of the process.

3. A method according to claim 1 comprising the step of linking, in a further model, a plurality of modelled process tasks of a similar type, and measuring, as a group, the performance of those similar-type process tasks.

4. A method according to claim 1 wherein the performance of the process is measured by generating reports at varying levels of abstraction corresponding to hierarchical levels within the canonical model.

5. A method according to claim 1 further comprising the step of recording the reports and measuring and displaying as part of a report, a trend of compliance based on changes over the course of a predetermined number of prior reports.

6. A method according to claim 1 wherein the model is a hierarchical series of elements, each representing a type of process.
